(19) United States
(12) Patent Application Publication
(10) Pub. No.: US 2026/0299530 A1
(43) Pub. Date: Oct. 1, 2026

(54) PROCESSING APPARATUS AND METHOD FOR OPTIMIZING HEAT DISSIPATION IN HEAT DISSIPATION MEMBER

(71) Applicant: SALCOMP (SHENZHEN) CO., LTD., Shenzen (CN)

(72) Inventors: Hao-Jun CHEN, Taipei City (TW); Ruo-Ting CHENG, Taipei City (TW)

(73) Assignee: SALCOMP (SHENZHEN) CO., LTD., Shenzen (CN)

(21) Appl. No.: 19/240,546

(22) Filed: Jun. 17, 2025

(30) Foreign Application Priority Data
Mar. 26, 2025 (TW) 114111589

(51) Int. Cl. G05B 13/02; F28F 99/00; G05B 13/04; H05K 7/20

(52) U.S. Cl. CPC G05B 13/027; G05B 13/048; F28F 99/00; F28F 2200/00; H05K 7/2039

(57) ABSTRACT

A processing apparatus for optimizing heat dissipation in heat dissipation member, which includes a storage and a processor. The processor runs a neural network model and executes following actions: generating multiple label temperatures on multiple virtual sample models based on simulation parameter; training the neural network model by using the simulation parameter, the multiple virtual sample models, all the label temperatures, and all labeled regions; and generating multiple predicted temperatures and a predicted region on a virtual test model based on component parameter and the virtual test model, where the multiple predicted temperatures indicate temperatures of multiple locations on a test circuit board, and the predicted region indicates an optimal heat dissipation region of a physical heat dissipation member coated or arranged on the test circuit board.

### CROSS-REFERENCE TO RELATED APPLICATION

This application claims benefit of priority to Taiwanese Patent Application No. 114111589 filed Mar. 26, 2025, the entire contents of which are incorporated herein by reference.

### BACKGROUND OF THE DISCLOSURE

### Technical Field

The present disclosure relates to a heat conduction technology, and more particularly to a processing apparatus for optimizing heat dissipation of heat dissipation member and method for the same.

### Description of Related Art

The design and manufacturing technology for printed circuit boards (PCB) become more complicated as the performance of electronic devices are improved. The printed circuit boards generally contain lots of electronic components, and the electronic components generate significant heat during the operation thereof. The electronic components may suffer to overheat problem in case that the heat dissipation is not treated effectively. Accordingly, the stability, reliability and service life of the entire system might be affected.

The heat dissipation member (such as thermal paste) is one of common heat dissipation materials, and is widely employed in heat transfer application between printed circuit boards and other heat sources (namely, the electronic components generate heat energy). However, the users have difficulty to directly know the current temperature of each region on the printed circuit board, and the users also have difficulty to the coating region of the heat dissipation glue on the printed circuit board and the coating amount of the heat dissipation glue in order to achieve the optimal heat dissipation effect. Therefore, it is an important issue for the skilled in the art to have quick prediction for the temperature of each region on a printed circuit board, and the coating region as well as the coating amount of the heat dissipation glue.

### SUMMARY OF THE DISCLOSURE

The object of the present disclosure is to provide a processing apparatus and method for optimizing heat dissipation of heat dissipation member, thus solve the problem in the related art, namely, the difficulty to know optimal region for coating/arranging heat dissipation member and the coating amount/arranging amount to achieve the optimal heat dissipation effect.

Accordingly, the present disclosure provides a processing apparatus for optimizing heat dissipation of heat dissipation member, the processing apparatus comprising:
a memory configured to store a plurality of instructions, a plurality of virtual sample models corresponding to a plurality of sample circuit boards, a simulation parameter of the plurality of sample circuit boards, a virtual test model to corresponding to a test circuit board, and a component parameter of the test circuit board, wherein a labelled region on each of the virtual sample models has a virtual heat dissipation member, the labelled region indicating an optimal heat dissipation region of a physical heat dissipation member coated or arranged on the corresponding sample circuit board; and
a processor connected to the memory and configured to run a neural network model and access the plurality of instructions to perform following actions:
action a) generating a plurality of labelled temperatures on each of the virtual sample models according to the simulation parameter;
action b) training the neural network model by using the simulation parameter, the plurality of virtual sample models, all of the labelled temperatures, and all of the labelled regions; and
action c) using the trained neural network model to generate a plurality of predicted temperatures and a predicted region on the virtual test model based on the component parameter and the virtual test model,
wherein the plurality of predicted temperatures indicate respective temperatures of a plurality of locations on the test circuit board, and the predicted region indicates an optimal heat dissipation region on the test circuit board to coat or arrange the physical heat dissipation member.

Accordingly, the present disclosure provides a processing method for optimizing heat dissipation of heat dissipation member, the method comprising:
step a) using a processor to generate a plurality of labelled temperatures on each of a plurality of virtual sample models according to a simulation parameter of a plurality of sample circuit boards, wherein the plurality of virtual sample models are respectively corresponding to the plurality of sample circuit boards, a labelled region on each of the virtual sample models has a virtual heat dissipation member, the labelled region indicates an optimal heat dissipation region to coat or arrange a physical heat dissipation member on the corresponding sample circuit board;
step b) using the processor to train the neural network model by the simulation parameter, the plurality of virtual sample models, all of the labelled temperatures, and all of the labelled regions; and
step c) using processor to run the trained neural network model to generate a plurality of predicted temperatures and a predicted region on the virtual test model based on a component parameter of a test circuit board and a virtual test model corresponding to the test circuit board,
wherein the plurality of predicted temperatures indicate respective temperatures of a plurality of locations on the test circuit board, and the predicted region indicates an optimal heat dissipation region on the test circuit board to coat or arrange the physical heat dissipation member.

In comparison with related art, the present invention first performs temperature simulation for circuit board and trains the neural network model with the virtual model of the circuit board and the simulation parameter, thus predict the temperature of each location on the circuit board and the optimal range for coating or arranging physical heat dissipation member. Therefore, the present disclosure can fast deduce the temperature of each region on the test printed circuit board and the regions and coating amount/arranging amount for coating or arranging the heat dissipation member.

### BRIEF DESCRIPTION OF THE DRAWINGS

FIG. 1 is a block diagram showing the processing apparatus for optimizing heat dissipation of heat dissipation member according to some embodiments of the present disclosure.

FIG. 2A shows the top view of the sample circuit board according to some embodiments of the present disclosure.

FIG. 2B shows the perspective view of the virtual sample model according to some embodiments of the present disclosure.

FIG. 2C is a schematic view of the grid coordinate system according to some embodiments of the present disclosure.

FIG. 3 is a flowchart showing the method for optimizing heat dissipation of heat dissipation member according to some embodiments of the present disclosure.

FIG. 4A is a schematic view showing the first initial point cloud image according to some embodiments of the present disclosure.

FIG. 4B is a schematic view showing the first temperature point cloud image according to some embodiments of the present disclosure.

### DETAILED DESCRIPTION

The technical contents of this disclosure will become apparent with the detailed description of embodiments accompanied with the illustration of related drawings as follows. It is intended that the embodiments and drawings disclosed herein are to be considered illustrative rather than restrictive.

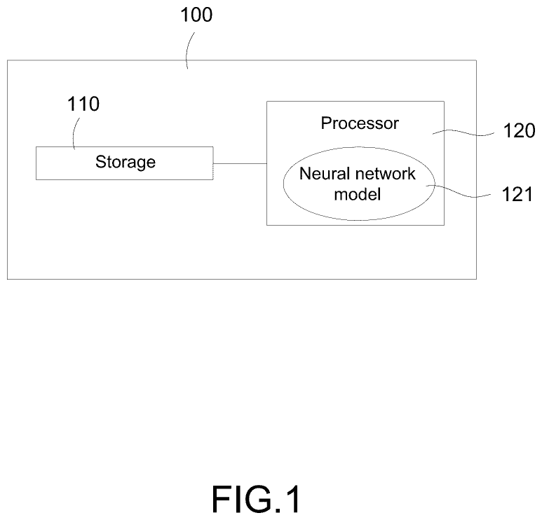

Please refer to FIG. 1. FIG. 1 is a block diagram showing the processing apparatus 100 for optimizing heat dissipation of heat dissipation member. In the embodiment, the processing apparatus 100 for optimizing heat dissipation of heat dissipation member (hereinafter briefed as the processing apparatus 100) includes a storage 110 and a processor 120, and the processor 120 is connected (in wired or wireless manner) to the storage 110.

In some embodiments, the processing apparatus 100 may be implemented by any data processing apparatus (for example, a desktop computer, a laptop computer, or a tablet computer, and so on) or a server (for example, a cloud server, a virtual server, or a rack-based server, and so on).

In this embodiment, the storage 110 stores a plurality of computer-executable instructions, a plurality of virtual sample models corresponding to a plurality of sample circuit boards, a simulation parameter of a plurality of sample circuit boards, a virtual test model corresponding to the test circuit board, and component parameter of the test circuit board. More particularly, the processing apparatus 100 in the present disclosure employs a plurality of sample circuit boards to train a neural network model, and predicts the relevant information of the test circuit board with the trained neural network model.

In some embodiments, the memory 110 may be implemented by a flash memory, a read-only memory, a hard disk, or any storage component with equivalent function.

In some embodiments, each of the computer-executable instructions can be implemented by any software or firmware. When the processor 120 reads the memory 110 and executes each computer-executable instruction, the processing method for optimizing heat dissipation of the heat dissipation member disclosed in the present disclosure can be implemented, which will the described in detail later.

The sample circuit board is a physical circuit board used for training. In some embodiments, a physical heat dissipation member is coated or arranged on an optimal heat dissipation region of each sample circuit board. The optimal heat dissipation region is a region with the optimal heat dissipation effect and heat conduction effect obtained after the user conducts lots of experiments in advance. Namely, when the physical heat dissipation member is coated or arranged on the optimal heat dissipation region of each sample circuit board, each sample circuit board has the optimal heat dissipation effect and heat conduction effect.

In some embodiments, each sample circuit board may be implemented by any type of printed circuit board (for example, a rigid printed circuit board or a flexible printed circuit board, and so on). In some embodiments, the physical heat dissipation member can be implemented by any type of heat dissipation member with heat dissipation and thermal conductivity. For example, the physical heat dissipation member may be implemented by heat dissipation colloid (such as thermal conductive adhesive) or by heat sink.

In this embodiment, a labelled region is arranged on each virtual sample model, and a virtual heat dissipation member is provided on the labelled region. In this embodiment, the labelled region indicates the optimal heat dissipation region of the physical heat dissipation member coated or arranged on the corresponding sample circuit board. In other words, the labelled region is a virtual region defined on each virtual sample model and is used to simulate the optimal heat dissipation region on the corresponding sample circuit board.

In some embodiments, each virtual sample model may be implemented by any type of three-dimensional model. In some embodiments, the virtual heat dissipation member may be virtual information in a three-dimensional virtual space and used for simulating the heat dissipation and heat conduction state of the physical heat dissipation member. The virtual information is, for example, virtual colloid information or virtual heat sink information.

In some embodiments, each virtual sample model may have a plurality of virtual components. Those virtual components are virtual electronic components in a three-dimensional virtual space and used to simulate the operation of a plurality of physical components arranged on a sample circuit board.

In some embodiments, a plurality of physical components may be implemented by any type of physical elements. For example, the physical component may be an inductor, a capacitor, a bridge (such as a network bridge), a housing, a cover or a wooden support rack.

In some embodiments, the simulation parameter may include grid size, virtual region respectively corresponding to each of the plurality of physical components on each sample circuit board, a location of a labelled region on each virtual sample model, respective power loss of each of all physical components, respective material property of all physical components, respective upper temperature limit of all physical components, and respective heat transfer equation of all physical components and physical heat dissipation members, and so on. But the scope of the present disclosure is not limited to above examples.

In some embodiments, the grid size may indicate the size of each grid of a grid coordinate system in a three-dimensional virtual space (for example, the length, width, and height of each grid is corresponding to one centimeter in the real space). The grid coordinate system is a virtual coordinate system known the skilled in this art and the detailed description thereof is not repeated here.

In some embodiments, the virtual region corresponding to each physical component on each sample circuit board indicates a three-dimensional virtual region of a virtual component in the grid coordinate system, where the virtual component is used to simulate each physical component.

In some embodiments, the processor 120 may convert the three-dimensional real region occupied by each physical component (namely belonging to each physical component) in the real coordinate system (for example, the world coordinate system) into the three-dimensional virtual region occupied by the corresponding virtual component (namely belonging to corresponding virtual component) in the grid coordinate system in advance by using any coordinate system algorithm, thus obtain the virtual region corresponding to each physical component.

In some embodiments, the location of the labelled region on each virtual sample model indicates the three-dimensional virtual region of the virtual heat dissipation member in the grid coordinate system.

In some embodiments, the power loss of each physical component indicates the power consumed by each physical component during the conversion of electrical energy into useless heat energy.

In some embodiments, the material property of each physical element indicates the thermal conductivity or thermal conductivity coefficient of each physical component.

In some embodiments, the upper temperature limit of each physical component indicates the highest operating temperature withstandable by each physical component. Namely, the physical component cannot function normally when the temperature upper-limit is exceeded.

In some embodiments, the heat transfer equation for each physical element indicates the temporal temperature change of each physical element.

In some embodiments, the heat transfer equation for the physical heat dissipation member indicates the temporal temperature change of the physical heat dissipation member changes.

In some embodiments, the component parameter may include a virtual region corresponding to each of a plurality of other physical components on the test circuit board, the power losses of all other physical components, the respective material property (for example, thermal conductivity) of all other physical components, the respective upper temperature limit of all other physical components, and the respective heat transfer equation of all other physical components. The above-mentioned multiple other physical components on the test circuit board may be the same or different with the multiple physical components on the sample circuit board.

Notably, the definitions of virtual region, power loss, material property (such as thermal conductivity), upper temperature limit and heat transfer equation of other physical components in the component parameter are substantially similar to the definitions of virtual region, power loss, material property upper temperature limit and heat transfer equation of the above-mentioned physical components. The only difference is that the parameter of the other physical components is for the test circuit board, while the parameter of the physical components is for sample circuit board. Therefore, the description for the component parameter of the other physical components is not detailed here.

In some embodiments, based on the grid size, the processor 120 may use a computational fluid dynamics (CFD) model to establish a corresponding virtual test model and according to the virtual region corresponding to each physical component on each sample circuit board and the location of the labelled region on each virtual sample model.

In some embodiments, the computational fluid dynamics model may be implemented by any type of simulation software having a heat conduction simulation function (for example, ANSYS Fluent software or OpenFOAM software, and so on).

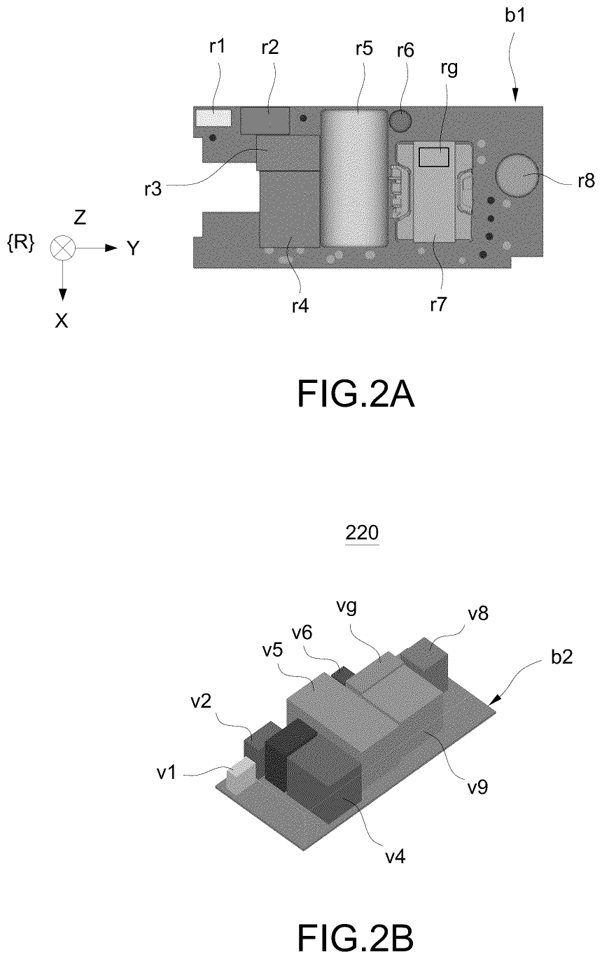

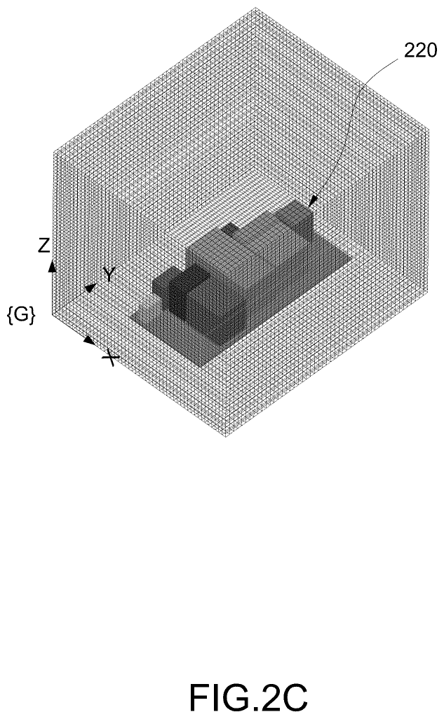

The following example describes the way to generate a virtual test model. With reference to FIGS. 2A to 2C, FIG. 2A shows the top view of the sample circuit board 210 according to some embodiments of the present disclosure, FIG. 2B shows the perspective view of the virtual sample model 220 according to some embodiments of the present disclosure, and FIG. 2C is a schematic view of the grid coordinate system {G} according to some embodiments of the present disclosure.

As shown in FIG. 2A, the sample circuit board 210 in the real coordinate system {R} has a physical substrate b1, a plurality of physical components r1-r8 are disposed on the physical substrate b1, and a physical heat dissipation member rg is coated or arranged on the physical component r. Besides, the physical substrate b1 itself can also be regarded as a physical component.

In other words, the sample circuit board 210 has physical regions respectively occupied by the physical substrate b1, the physical components r1-r8, and the physical heat dissipation member rg in the real coordinate system {R}.

As shown in FIG. 2B~2C, the processor 120 establishes a grid coordinate system {G} in three-dimensional space based on the grid size, and establishes a virtual test model 220 corresponding to the sample circuit board 210 in the grid coordinate system {G} according to the virtual regions (namely, the virtual region respectively occupied by (belonging to) the virtual substrate b2 and the virtual components v1~v8 in the grid coordinate system {G}) corresponding to the physical substrate b1 and the physical components r1~r8 respectively, and according to the location of the labelled region (namely, the virtual region occupied by (belonging to) the virtual heat dissipation member vg in the grid coordinate system {G}).

In some embodiments, the storage 110 stores a virtual test model corresponding to the test circuit board. The virtual test model can be generated by above simulation for the sample circuit board. Namely, the virtual test model is generated in the a three-dimensional virtual space by virtualizing the physical test circuit board. The simulation method has been described in detail in the above paragraphs; therefore, the further description thereof is omitted here for brevity.

In some embodiments, the test circuit board may be a circuit board different from the sample circuit board, and the test circuit board has not been coated or arranged with a physical heat dissipation member. In some embodiments, the test circuit board may also be implemented by any type of printed circuit board. More particularly, the test circuit board in the present disclosure first uses the trained neural network model to inference, and then the physical heat dissipation member is coated or arranged with coating amount/arranging amount indicated by the inference result on the regions of the circuit board, where the regions are also indicated by the inference result. Thereby, an improved heat dissipation effect can be obtained. In some embodiments, the physical heat dissipation member is a heat dissipation colloid, and the coating amount is the total amount of colloid coated on the region indicated by the inference result. In some embodiments, the physical heat dissipation member is a heat sink, and the arranging amount is the size of the heat sink arranged on the region indicated by the inference result.

In this embodiment, the processor 120 performs the neural network model 121 and accesses the above instructions to execute the processing method for optimizing the heat dissipation of the heat dissipation member, which will be described in the subsequent paragraphs.

In some embodiments, the neural network model 121 may be implemented by any neural network model for image processing (for example, a convolutional neural network model, a deep neural network model, a YOLO model, or a transformer model, and so on).

In some embodiments, the processor 120 can be implemented by a central processing unit (CPU), a micro control unit (MCU), a programmable logic controller (PLC), a system on chip (SoC), or a field programmable gate array (FPGA) and so on.

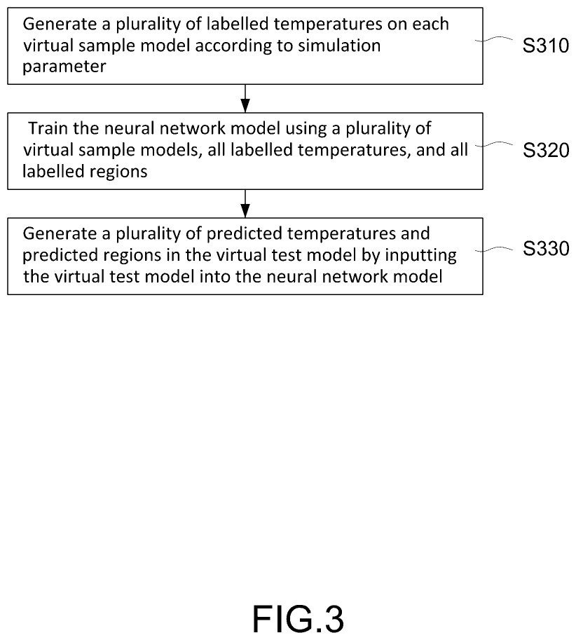

With reference also to FIG. 3, FIG. 3 is a flowchart showing the method for optimizing heat dissipation of heat dissipation member according to some embodiments of the present disclosure. The method is applicable to the processing apparatus 100 shown in FIG. 1.

As described above, the storage 110 of the processing apparatus 100 stores a plurality of virtual sample models and simulation parameter of a plurality of sample circuit boards, and stores a virtual test model and component parameter of the test circuit board. As shown in FIG. 3, in step S310, the processor 120 first generates a plurality of labelled temperatures on each virtual sample model according to simulation parameter.

In some embodiments, based on the simulation parameter, the processor 120 may use temperatures at the grids, which are occupied by each virtual sample model generated by the computational fluid dynamics model in the grid coordinate system {G}, as the labelled temperatures.

More particularly, the processor 120 may, based on the simulation parameter, sets respective coordinates, power loss, material property (such as thermal conductivity), upper temperature limit and heat transfer equation at grids occupied by each virtual sample model in the grid coordinate system {G}, thus generate a plurality of simulation result files (such as vtk files or csv files) corresponding to each virtual sample model. In some embodiments, the plurality of simulation result files respectively includes the power loss, material property, upper temperature limit and heat transfer equation of each grid in the corresponding virtual sample model. Besides, after the user imports the coordinate system (such as the above-mentioned grid coordinate system) into the simulation software, the plurality of simulation result files can be converted into a first initial point cloud image (there is a one-to-one correspondence between the grid and the point cloud). The above mentioned first initial point cloud image has difference with the pure point cloud distribution image in that the first initial point cloud image incorporates the simulation parameter such that each point cloud in the first initial point cloud image incorporates corresponding information including temperature, pressure, speed and so on. Furthermore, based on each first initial point cloud image, the processor 120 uses the temperature of each point cloud in the first initial point cloud image, which is generated by the computational fluid dynamics model, as the respective labelled temperature.

In some embodiments, the first initial point cloud image is a simulation result file having coordinate system information, and the plurality of point clouds of the first initial point cloud image respectively has corresponding coordinates, power loss, material property (such as thermal conductivity), upper temperature limit and heat transfer equation.

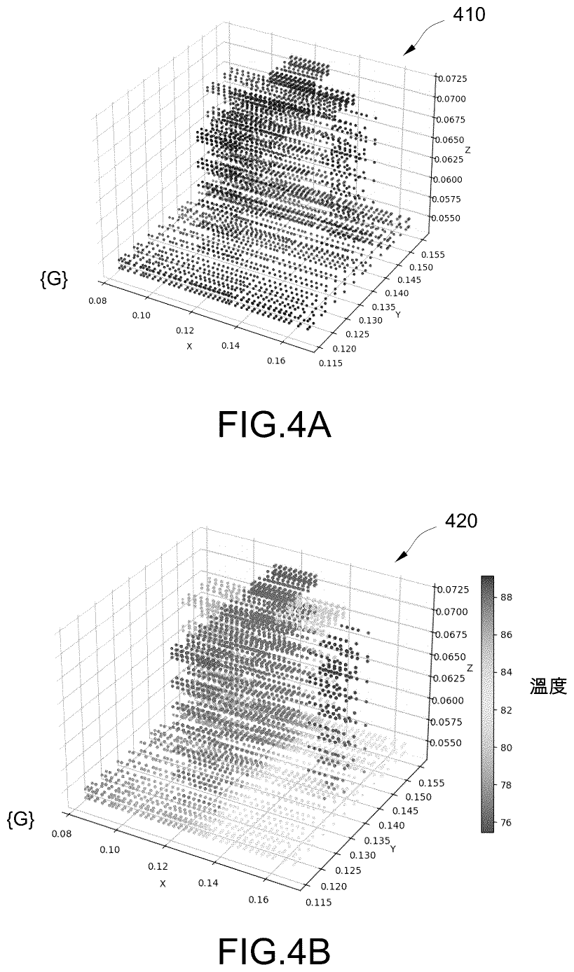

The first initial point cloud image is described hereinafter with a tangible example. With reference also to FIG. 4A, FIG. 4A is a schematic view showing the first initial point cloud image 410 according to some embodiments of the present disclosure.

As shown in FIG. 4A, a virtual sample mode has a plurality of point clouds at a plurality of grids occupied by (belonging to) the virtual sample mode in the grid coordinate system {G}. Each of the point clouds in the first initial point cloud image 410 has corresponding coordinates, power loss, material property, upper temperature limit and heat transfer equation.

In some embodiments, the processor 120 may set different colors for different temperature values of the labelled temperature for each first initial point cloud image to generate a corresponding first temperature point cloud image. The plurality of point clouds in each first temperature point cloud image respectively has a corresponding color, coordinate, power loss, material property, upper temperature limit and heat transfer equation.

The first temperature point cloud image is described hereinafter with a tangible example. With reference also to FIG. 4B, FIG. 4B is a schematic view showing the first temperature point cloud image 420 according to some embodiments of the present disclosure.

As shown in FIG. 4B, a virtual sample model has a plurality of point clouds at a plurality of grids occupied by (belonging to) the virtual sample model in the grid coordinate system {G}. Each of the point clouds in the first temperature point cloud image 420 has a labelled temperature, corresponding color, coordinate, power loss, material property, upper temperature limit and heat transfer equation. In this embodiment, when the labelled temperature of the point cloud in the first temperature point cloud image 420 has higher temperature value, the color corresponding to the labelled temperature is more inclined to the first color (for example, red color). On the contrary, when the labelled temperature of the point cloud in the first temperature point cloud image 420 has lower temperature value, the color corresponding to the labelled temperature is more inclined to the second color (for example, blue color).

In some embodiments, the processor 120 may control a display (not shown) in the processing apparatus 100 or an external display (not shown) to display each first initial point cloud image or each first temperature point cloud image for a user to view.

Refer to FIG. 3 again. In step S320, the processor 120 trains the neural network model 121 using simulation parameter, a plurality of virtual sample models, all labelled temperatures, and all labelled regions.

In some embodiments, the processor 120 may use a plurality of simulation result files generated by the simulation parameter and each virtual sample model as training samples. More specifically, the processor 120 may uses the above information of the plurality of point clouds (namely, coordinates, power loss, material property, upper temperature limit and heat transfer equation) in the first initial point cloud image as training samples, where the first initial point cloud image is generated according to the simulation parameter and corresponding to each of the virtual sample models. Afterward, the processor 120 may use the labelled regions on each virtual sample model and the multiple labelled temperatures as multiple training labels corresponding to the multiple training samples. Then, the processor 120 may update the neural network model 121 by using a plurality of training samples corresponding to each simulation result file (or the first initial point cloud image) and a plurality of training labels corresponding to each training sample.

In some embodiments, the processor 120 may input each training sample into the neural network model 121 to generate corresponding result region and a result temperature of each point cloud, which are used as a plurality of result labels. The processor 120 further calculate the loss values between the plurality of result labels (corresponding to each training sample) and the plurality of training labels; namely, the loss value between the result temperature and the labelled temperature of the point cloud at the same coordinates, and the loss value between the coordinates of the result region and the coordinates of the labelled region in the grid coordinate system {G}.

Afterward, the processor 120 uses the calculated loss value to perform a backpropagation algorithm on the neural network model 121 to update the parameters in the neural network model 121 (namely, the weight value of each of the multiple neural network layers in the neural network model 121). In this way, the processor 120 can repeat the same steps mentioned above. When the number of repeats is greater than a specific number (namely, the preset number of training times), the update for the neural network model 121 can be finished, namely, the training stage is completed.

In step S330, the processor 120 generates a plurality of predicted temperatures and predicted regions in the virtual test model by using the neural network model according to the component parameter and the virtual test model.

In other words, when a new test circuit board needs to be inferred, the user generates a new virtual test model for the new test circuit board by the above-mentioned simulation method. Afterward, the processor 120 imports the new virtual test model and the corresponding component parameter into the trained neural network model 121. Therefore, by the processing of the neural network model 121, the virtual test model and the corresponding component parameter can be converted to a plurality of predicted temperatures and predicted regions on the virtual test model, namely, the application stage of the trained neural network model 121.

In this embodiment, the plurality of predicted temperatures indicate the temperatures of a plurality of locations on the test circuit board, and the predicted region indicates the optimal heat dissipation region of the physical heat dissipation body coated or disposed on the test circuit board.

In some embodiments, based on the component parameter, the processor 120 may set respective coordinates, power loss, material property, upper temperature limit, and heat transfer equations for the plurality of grids occupied by (belonging to) the virtual test model in the grid coordinate system {G}, and generates a second result file (such as a vtk file or a csv file) corresponding to the virtual test model. After the coordinate system (such as the above-mentioned grid coordinate system) is imported into the second result file, the second result file can be converted into a second initial point cloud image, which is similar to the first initial point cloud image 410 in FIG. 4A. Besides, the processor 120 inputs the second result file (or the second initial point cloud image) into the trained neural network model 121 to obtain, from the output of the neural network model 121, the temperature of each grid in the second result file (or the temperature of each point cloud in the second initial point cloud image) and the predicted regions on the second initial point cloud image.

In some embodiments, each of the plurality of point clouds of the second initial point cloud image has corresponding coordinate, power loss, material property, upper temperature limit, and heat transfer equation.

Afterward, the processor 120 may use the temperature of each point cloud in the second initial point cloud image and the predicted region on the second initial point cloud image as the predicted temperature of each of the grids occupied by (belong to) the virtual test model in the grid coordinate system {G} and the predicted region on the virtual test model based on the position relationship between the grid and the point cloud (namely, finding the grid and point cloud having the same coordinate in the grid coordinate system {G}).

In some embodiments, the processor 120 may set different colors for different predicted temperature values on each second initial point cloud image to generate a corresponding second temperature point cloud image. The point clouds in each second temperature point cloud image also have corresponding colors, coordinates, power loss, material property, upper temperature limit and heat transfer equation (similar to the first temperature point cloud image 420 in FIG. 4B).

In some embodiments, the processor 120 may control a display (not shown) in the processing apparatus 100 or an external display (not shown) to display the second initial point cloud image or the second temperature point cloud image for the user to view.

In some embodiments, the user can process the physical test circuit board (for example, coating or arranging physical heat dissipation member thereon) according to the predicted temperature and predicted regions output by the neural network, thus obtain finished test circuit board. Besides, the processor 120 may calculate the difference between the actually-detected temperature and the predicted temperature at each location on the finished test circuit board, and determine whether an average value of those differences is greater than a difference threshold value pre-set by the user. When the average value of those differences is greater than the difference threshold, the inference result of the neural network model 121 is determined to be inaccurate. At this time, the processor 120 can train the neural network model 121 again by using other sample circuit boards and corresponding simulation parameter with the same training way described above.

By above steps, the present disclosure can use the trained neural network model 121 to automatically generate the temperature at each location on the test circuit board and to automatically generate the optimal range for coating or arranging the physical heat dissipation member on the test circuit board. Besides, the present disclosure can determine the coating amount/arranging amount of the physical heat dissipation member according to above optimal range. Therefore, the present disclosure can easily obtain the temperature at each location on the test circuit board and the optimal range for coating or arranging the physical heat dissipation member on the test circuit board without needing to conduct lots complicated inspections and testing tasks.

In summary, the present disclosure combines temperature simulation in advance and neural network algorithm for the circuit board, and predicts the temperature of each location on the circuit board and the optimal range for coating or arranging physical heat dissipation member. Therefore, the present disclosure can fast deduce the temperature of each region on the test printed circuit board and the regions and coating amount/arranging amount for coating or arranging the heat dissipation member. Besides, the present disclosure converts a virtual model with simulated temperature into a visual point cloud image so that the user can quickly know the temperature of each location.

While this disclosure has been described by means of specific embodiments, numerous modifications and variations may be made thereto by those skilled in the art without departing from the scope and spirit of this disclosure set forth in the claims.

What is claimed is:

1. A processing apparatus for optimizing heat dissipation of heat dissipation member, the processing apparatus comprising:
a memory configured to store a plurality of instructions, a plurality of virtual sample models corresponding to a plurality of sample circuit boards, a simulation parameter of the plurality of sample circuit boards, a virtual test model to corresponding to a test circuit board, and a component parameter of the test circuit board, wherein a labelled region on each of the virtual sample models has a virtual heat dissipation member, the labelled region indicating an optimal heat dissipation region of a physical heat dissipation member coated or arranged on the corresponding sample circuit board; and
a processor connected to the memory and configured to run a neural network model and access the plurality of instructions to perform following actions:
action a) generating a plurality of labelled temperatures on each of the virtual sample models according to the simulation parameter;
action b) training the neural network model by using the simulation parameter, the plurality of virtual sample models, all of the labelled temperatures, and all of the labelled regions; and
action c) using the trained neural network model to generate a plurality of predicted temperatures and a predicted region on the virtual test model based on the component parameter and the virtual test model,
wherein the plurality of predicted temperatures indicate respective temperatures of a plurality of locations on the test circuit board, and the predicted region indicates an optimal heat dissipation region on the test circuit board to coat or arrange the physical heat dissipation member.

2. The processing apparatus in claim 1, wherein the simulation parameter comprises a grid size of a grid coordinate system in a three-dimensional virtual space, a virtual region corresponding to each of a plurality of physical components on each of the sample circuit boards, a location of the labelled region on each of the virtual sample models, power losses of all of the physical components, respective material property of all of the physical components, respective upper temperature limit of all of the physical components, and respective heat transfer equation of all of the physical components and the physical heat dissipation members;
wherein the component parameter comprises a virtual region corresponding to each of the other physical components on the test circuit board, power losses of all of the other physical components, respective material property of all of the other physical components, respective upper temperature limit of all of the other physical components, and respective heat transfer equation of all the other physical components.

3. The processing apparatus in claim 2, wherein the processor is configured to perform following action:
based on the grid size, using a computational fluid dynamics model to establish the corresponding virtual test model according to the virtual region corresponding to each of the physical components on each of the sample circuit boards and the location of the labelled region on each of the virtual sample models.

4. The processing apparatus in claim 1, wherein in the action a), the processor is configured to perform following action:
based on the simulation parameter, using a computational fluid dynamics model to generate a temperature respectively at a plurality of grids occupied by each of the virtual sample models in a grid coordinate system and using the temperature as the labelled temperature.

5. The processing apparatus in claim 1, wherein in the action b), the processor is configured to perform following actions:
generating a plurality of simulation result files corresponding to the plurality of virtual sample models respectively according to the simulation parameter;
using the plurality of simulation result files as a plurality of training samples;
using the labelled region and the plurality of label temperatures on each of the virtual sample models as a plurality of training labels corresponding to the plurality of training samples; and
using the plurality of training samples and the plurality of training labels corresponding to the plurality of training samples to update the neural network model.

6. A processing method for optimizing heat dissipation of heat dissipation member, the method comprising:
step a) using a processor to generate a plurality of labelled temperatures on each of a plurality of virtual sample models according to a simulation parameter of a plurality of sample circuit boards, wherein the plurality of virtual sample models are respectively corresponding to the plurality of sample circuit boards, a labelled region on each of the virtual sample models has a virtual heat dissipation member, the labelled region indicates an optimal heat dissipation region to coat or arrange a physical heat dissipation member on the corresponding sample circuit board;
step b) using the processor to train the neural network model by the simulation parameter, the plurality of virtual sample models, all of the labelled temperatures, and all of the labelled regions; and
step c) using processor to run the trained neural network model to generate a plurality of predicted temperatures and a predicted region on the virtual test model based on a component parameter of a test circuit board and a virtual test model corresponding to the test circuit board,
wherein the plurality of predicted temperatures indicate respective temperatures of a plurality of locations on the test circuit board, and the predicted region indicates an optimal heat dissipation region on the test circuit board to coat or arrange the physical heat dissipation member.

7. The method in claim 6, wherein the simulation parameter comprises a grid size of a grid coordinate system in a three-dimensional virtual space, a virtual region corresponding to each of a plurality of physical components on each of the sample circuit boards, a location of the labelled region on each of the virtual sample models, power losses of all of the physical components, respective material property of all of the physical components, respective upper temperature limit of all of the physical components, and respective heat transfer equation of all of the physical components and all of the physical heat dissipation members;
wherein the component parameter comprises a virtual region corresponding to each of other physical components on the test circuit board, power losses of all of the other physical components, respective material properties of all of the other physical components, respective upper temperature limit of all of the other physical components, and respective heat transfer equation of all the other physical components.

8. The method in claim 7, further comprising:
based on the grid size, the processor using a computational fluid dynamics model to establish the corresponding virtual test model according to the virtual region corresponding to each of the physical components on each of the sample circuit boards and the location of the labelled region on each of the virtual sample models.

9. The method in claim 6, wherein the step a) further comprises:
based on the simulation parameter, the processor using a computational fluid dynamics model to generate a temperature respectively at a plurality of grids occupied by each of the virtual sample models in a grid coordinate system and using the temperature as the labelled temperature.

10. The method in claim 6, wherein the step b) further comprises:
the processor generating a plurality of simulation result files corresponding to the plurality of virtual sample models respectively according to the simulation parameter;
the processor using the plurality of simulation result files as a plurality of training samples;
the processor using the labelled region and the plurality of label temperatures on each of the virtual sample models as a plurality of training labels corresponding to the plurality of training samples; and
the processor using the plurality of training samples and the plurality of training labels corresponding to the plurality of training samples to update the neural network model.
